(19) United States
(12) Patent Application Publication
(10) Pub. No.: US 2023/0196193 A1
(43) Pub. Date: Jun. 22, 2023

(54) Methods, Devices, and Computer Programs for Training a Machine Learning Model and For Generating Training Data

(71) Applicant: Bayerische Motoren Werke Aktiengesellschaft, Muenchen (DE)

(72) Inventors: Daniel Knobloch, Cupertino, CA (US); Benjamin Schulz, Dresden (DE)

(21) Appl. No.: 17/925,078

(22) PCT Filed: Mar. 31, 2021
(86) PCT No.: PCT/EP2021/058396

§ 371 Date: Nov. 14, 2022

(30) Foreign Application Priority Data
Jul. 8, 2020 (DE) 10 2020 117 963.4

(51) Int. Cl. G06N 20/00

(52) U.S. Cl. CPC G06N 20/00

(57) ABSTRACT

A computer-implemented method trains a machine learning model. The method includes training the machine learning model on the basis of data representing at least two different vehicle environments. The machine learning model is trained, on the basis of data from a time-of-flight distance measurement of a distance between a key device and a vehicle, to determine a position of the key device relative to the vehicle.

The present application is the U.S. national phase of PCT Application PCT/EP2021/058396 filed on Mar. 31, 2021, which claims priority of German patent application No. 102020117963.4 filed on Jul. 8, 2020, which is incorporated herein by reference in its entirety.

### TECHNICAL FIELD

Exemplary embodiments deal with methods, devices and computer programs for training a machine learning model and for generating training data for such training, in particular deal with the training of a machine learning model for determining a position of a key device relative to a vehicle.

### BACKGROUND

A prerequisite for using so-called keyless entry systems (also called passive entry/passive go systems) is to develop a secure and simultaneously robust method for authenticating the authorized user with respect to the vehicle.

This also includes a sufficiently accurate estimation of the location of the user or of the authentication device, (as of when a vehicle can be unlocked or is intended to be locked) and whether the vehicle key (smartphone or conventional key) is inside or outside the vehicle in order to grant or refuse clearance for starting the engine.

In the case of conventional keys, this is carried out at very low radio frequencies. Currently, most passive entry systems are based on narrowband radio technologies in the LF band (low-frequency band, also long-wave band). As soon as the distance between the key and the vehicle is short enough, the vehicle key establishes a connection to the vehicle. After the connection has been established, localization is carried out in another LF frequency band. In this case, a defined signal is emitted by the key and one or more receiving antennas receive this signal with different signal strengths depending on the position in relation to the vehicle. The reason for this is the attenuation of an electromagnetic wave in different materials. Depending on the reception power of the signal at the different receiving nodes, it is possible to decide whether the key is close enough to the vehicle or is inside the vehicle.

When implementing this function in smartphones (programmable mobile telephones), high-frequency radio frequencies can be used for localization and make localization difficult.

There is a need to provide an improved approach to using smartphones as vehicle keys.

### SUMMARY

This need is taken into account by the exemplary embodiments of the present disclosure.

Exemplary embodiments of the present disclosure are based on the knowledge that the measured values are more dependent on the environment at higher frequencies, as are used by smartphones or other modern key devices, than at low frequencies.

Since a vehicle is a complex geometry whose electromagnetic behavior cannot be easily calculated, machine learning processes are used here, that is to say training data are measured at the vehicle, for example, and are converted into a machine learning model (ML model), with the result that the vehicle can then classify whether the authentication device is inside or outside the vehicle. Ideally, the entire solution space is covered, with the result that the classification does not fail at any point (wrong classification or blind spot). In some cases, the process involves a person holding a key at defined positions in the vehicle, at the vehicle and around the vehicle. In this case, the person carrying out the measurement knows whether the key is currently inside, outside or in the trunk. The performance values of the various receiving nodes are then linked to one another using this knowledge (inside, outside or in the trunk (described only with “inside” and “outside” below)). In some cases, such a training data set is recorded in an environment which is not highly specified. This is sufficient for measurements in the low-frequency range since the properties of the radio frequencies used for this purpose are sufficiently independent of the environment that such methods suffice. The ML model is then formed and a check is carried out in order to determine whether the model functions.

In some smartphones and other mobile devices which are used as a key device, a new technology—ultra wide band (UWB)—is used. This type of radio technology fundamentally differs from LF radio in that, instead of a powerful narrowband signal (that is to say low-frequency information is modulated onto a higher carrier frequency), a very wideband but low-power signal is transmitted in the SHF band (super high frequency, centimeter wave band, 3-30 GHz).

The use of a very broad spectrum (of at least 500 MHz, for example) makes it possible to carry out a precise time-of-flight (ToF) measurement. The ToF measurement can then be used to calculate the distance between the transmitter and the receiver using the constant of the speed of light. In addition to the ToF, the receive power (RXP) can likewise be used as a second feature for calculating the distance. In principle, it is possible to also apply the data processing process and the training of the ML model to this radio technology.

As a result of the high frequencies and therefore short wavelengths (approximately 3 to 7 centimeters) of the electromagnetic waves, the interfering influences of metal objects in the environment of the transmitter and receiver are substantially greater than in the LF band. At conductive geometries of the order of magnitude of the wavelength, an electromagnetic wave interacts very strongly, that is to say the wave is reflected, scattered and diffracted. LF radio has a wavelength order of magnitude in the single-digit kilometer range, which is why there are too few interactions between metal objects which are small in relation to the wavelength in the case of this radio. However, at wavelengths in the centimeter range, the body/engine block, other vehicles, reinforced concrete walls, gratings etc. cause a lot of interference. This is also due, inter alia, to the penetration depth of the waves into a conductor. The higher the frequency of the electromagnetic wave, the lower the penetration depth into this conductor or the possibility of also penetrating this conductor. This penetration depth is approximately 100 μm for LF and is approximately 1 μm for SHF. That is to say, high frequencies can be shielded much more easily than lower frequencies. In addition, the free space loss is proportional to the frequency, which in turn means that the UWB waves are already attenuated to a greater extent solely on account of their higher frequency. In addition, high-frequency waves are attenuated to a greater extent than low-frequency waves in non-transparent objects such as water or humidity.

All of this results in the UWB signal being influenced to such an extent by the environment that the recording of a training data set in a general environment that is not highly specified does not necessarily suffice to ensure that the model also functions in other environments. In principle, this would result in training data having to be recorded in all possible environments in order to be able to cover the solution space in all environments, which at best is very complicated and realistically is not possible since it is impossible to approach all conceivable vehicle environments and record training data there.

Exemplary embodiments of the present disclosure deal with being able to reduce the training effort in order to be able to generate a reliable ML model. It is therefore possible to classify whether an authentication device (for instance a key (also key fob) or smartphone) is inside or outside the vehicle. In this case, exemplary embodiments of the present disclosure are based on the knowledge that the effort needed to generate the training data can be reduced by training the machine learning model on the basis of two different vehicle environments, wherein the two different vehicle environments are as different as possible in relation to possible reflections. For example, it is possible to select one vehicle environment which is as free of reflections as possible and to select a further environment in which a multiplicity of reflections can be expected (for instance a vehicle environment in an underground garage with densely parked vehicles). The vehicle environments which are between the two extremes in relation to the reflections can be derived from these two vehicle environments by means of the machine learning model, in which case the data can also be additionally augmented in order to extend the training of the machine learning model beyond the two vehicle environments.

Exemplary embodiments of the present disclosure provide a computer-implemented method for training a machine learning model. The method comprises training the machine learning model on the basis of data representing at least two different vehicle environments. The machine learning model is trained, on the basis of data from a time-of-flight distance measurement of a distance between a key device and a vehicle, to determine a position of the key device relative to the vehicle. The use of data representing two different vehicle environments makes it possible to model the behavior of other vehicle environments, which are between the two examined vehicle environments in relation to possible reflections, by means of the machine learning model without the need for additional measurements in further vehicle environments.

For example, the at least two different vehicle environments may differ in relation to possible reflections at surfaces in the respective vehicle environment. In this case, it is possible to select, for example, vehicle environments which differ to the greatest possible extent in relation to the reflections in order to be able to also cover other vehicle environments which are between the extremes in relation to reflections.

In principle, there are a plurality of possible ways of generating the data relating to the different vehicle environments. On the one hand, the data may be measured. For example, the data representing at least two different vehicle environments may comprise at least one first data set, which was measured in a first vehicle environment, and at least one second data set, which was measured in a second vehicle environment. Vehicle environments which are available for measuring the data can therefore be used for training, for example.

Alternatively or additionally, the data may be generated using a physical simulation. In other words, the data representing at least two different vehicle environments may comprise at least one first data set, which is based on a physical simulation of a first vehicle environment, and at least one second data set, which is based on a physical simulation of a second vehicle environment, or was measured in a second vehicle environment. Vehicle environments in which it is not possible to generate data using a measurement can therefore be used to train the machine learning model, for example.

In addition, the measured or simulated data may be augmented. For example, the method may supplementing at least one data set with a plurality of additional calculated data units in order to obtain the data representing the at least two different vehicle environments. In other words, the measured or simulated data can be supplemented with further data which are based on a modification of the physically simulated or measured data. For example, the additional data units may be calculated by adding artificial noise on the basis of the respective data set. Alternatively or additionally, the additional data units may be calculated on the basis of a position-dependent error model based on the respective data set. Alternatively or additionally, the additional data units may be calculated by means of interpolation between the data relating to two positions on the basis of the respective data set. These approaches can be used to generate additional training data in an automated manner.

For example, the time-of-flight distance measurement and/or a received signal strength may be based on one or more signals from an ultra-wideband signal transmission. In the case of UWB signals, training of the machine learning model in different vehicle environments may be particularly advantageous on account of the wavelengths used.

In some exemplary embodiments, the machine learning model is trained, on the basis of data from a time-of-flight distance measurement of a distance between a key device and a vehicle and on the basis of a signal strength of a signal transmission between the key device and the vehicle, to determine a position of the key device relative to the vehicle. This makes it possible to determine the relative position of the key device in a more reliable manner.

Exemplary embodiments of the present disclosure also comprise a computer-implemented device for training a machine learning model. The device comprises one or more processors and one or more memory devices. The device is designed to carry out the method for training the machine learning model. Exemplary embodiments also provide a vehicle having a computing module, wherein the computing module is designed to determine the position of a key device relative to the vehicle with the aid of the machine learning model.

Exemplary embodiments of the present disclosure also provide a method for generating data sets for training a machine learning model. The data sets each comprise a plurality of data units with a position of a key device relative to a vehicle, a time-of-flight distance measurement between the key device and the vehicle and/or a signal strength of a signal transmission between the key device and the vehicle. The method comprises generating a first data set in a first vehicle environment. The method also comprises generating a second data set in a second vehicle environment. The two vehicle environments differ in relation to possible reflections at surfaces in the respective vehicle environment. This makes it possible to generate, for example, the training data for the method presented above.

Exemplary embodiments of the present disclosure also comprise a computer-implemented device for generating data sets for training a machine learning model. The device comprises one or more processors and one or more memory devices. The device is designed to carry out the method for generating data sets for training a machine learning model.

Exemplary embodiments of the present disclosure also comprise a program having a program code for carrying out at least one of the methods when the program code is executed on a computer, a processor, a control module or a programmable hardware component.

### BRIEF DESCRIPTION OF THE FIGURES

Some examples of devices and/or methods are explained in more detail merely by way of example below with reference to the accompanying figures, in which:

FIG. 1a shows a flowchart of an exemplary embodiment of a computer-implemented method for training a machine learning model;

FIG. 1b shows a block diagram of an exemplary embodiment of a computer-implemented device for training a machine learning model;

FIG. 2a shows a flowchart of an exemplary embodiment of a method for generating data sets for training a machine learning model; and

FIG. 2b shows a block diagram of an exemplary embodiment of a device for generating data sets for training a machine learning model.

### DESCRIPTION

Various examples are now described in more detail with reference to the accompanying figures which illustrate some examples. In the figures, the thicknesses of lines, layers and/or areas may be exaggerated for clarification.

It goes without saying that if an element is referred to as being “connected” or “coupled” to another element, the elements may be connected or coupled directly or via one or more intermediate elements. If two elements A and B are combined using an “or”, this should be understood as meaning the fact that all possible combinations are disclosed, that is to say only A, only B and A and B, unless explicitly or implicitly defined otherwise. An alternative expression for the same combinations is “at least one of A and B” or “A and/or B”. The same applies, mutatis mutandis, to combinations of more than two elements.

Unless defined otherwise, all terms (including technical and scientific terms) are used here in their conventional meaning in the field to which examples belong.

Exemplary embodiments of the present disclosure generally deal with locating an authentication device, for instance a key device, inside or outside a vehicle. Exemplary embodiments therefore relate, in particular, to authentication devices or key devices for keyless entry systems and keyless go systems of vehicles.

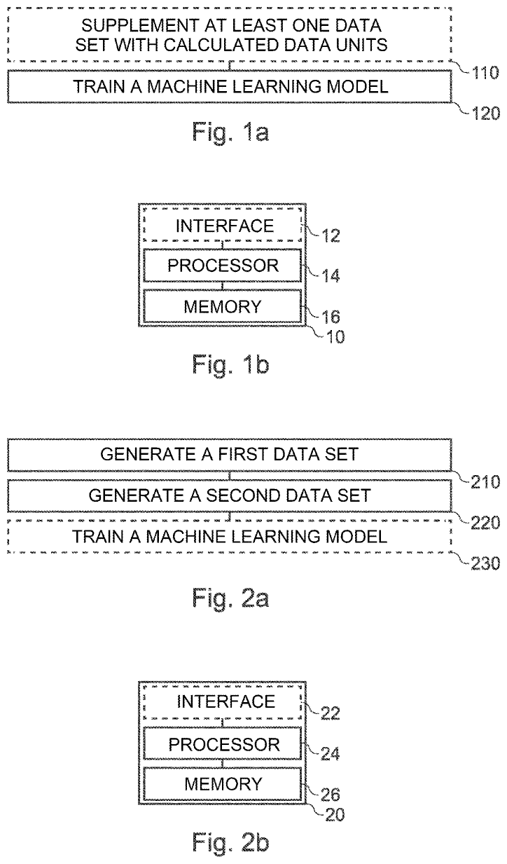

FIG. 1a shows a flowchart of an exemplary embodiment of a computer-implemented method for training a machine learning model. The method comprises training 120 the machine learning model on the basis of data representing at least two different vehicle environments. The machine learning model is trained, on the basis of data from a time-of-flight distance measurement of a distance between a key device and a vehicle, to determine a position of the key device relative to the vehicle.

FIG. 1b shows a block diagram of an exemplary embodiment of a corresponding computer-implemented device 10 for training the machine learning model. The device comprises one or more processors 14 and one or more memory devices 16. The device optionally also comprises an interface 12, for instance for receiving the training data or for providing the trained machine learning model. The one or more processors are coupled to the optional interface and to the one or more memory devices. The functionality of the device is generally provided by the one or more processors with the aid of the one or more memory devices and/or the optional interface. The device is designed to carry out the method from FIG. 1a.

The following description relates both to the method from FIG. 1a and to the corresponding device from FIG. 1b.

At least some aspects of the present disclosure relate to a method, a device and a computer program for training a machine learning model. Machine learning relates to algorithms and statistical models which can be used by computer systems to carry out a specific task without using explicit instructions, instead of relying on models and interference. In the case of machine learning, instead of a rule-based transformation of data, it is possible to use, for example, a transformation of data which may be derived from an analysis of progress and/or training data. Machine learning is used in a multiplicity of applications, for instance for recognizing objects in image data, for predicting time series, for pattern analysis etc. In this case, use is generally made of the fact that, in order to train a machine learning model which is intended to carry out a particular task, the so-called “training” of the model, so-called training data suffice as a basis in many cases, that is to say data which represent an example of which transformation is expected from the respective machine learning model.

For example, the content of images can be analyzed using a machine learning model or using a machine learning algorithm. So that the machine learning model can analyze the content of an image, the machine learning model can be trained using training images as an input and training content information as an output. As a result of the machine learning model being trained with a large number of training images and/or training sequences (for example words or sentences) and associated training content information (for example labels or comments), the machine learning model “learns” to recognize the content of the images, with the result that the content of images which are not included in the training data can be recognized using the machine learning model. The same principle may likewise be used for other types of sensor data: as a result of a machine learning model being trained using training sensor data and a desired output, the machine learning model “learns” a conversion between the sensor data and the output, which can be used to provide an output on the basis of non-training sensor data made available to the machine learning model. The data provided (for example sensor data, metadata and/or image data) can be preprocessed in order to obtain a feature vector which is used as the input for the machine learning model.

In the present case, the machine learning model is trained, on the basis of data from a time-of-flight distance measurement (also time-of-flight ranging) of a distance between a key device and a vehicle, to determine a position of the key device relative to the vehicle. In addition to the time-of-flight distance measurement, it is also possible to use a signal strength of a signal transmission between the key device and the vehicle (for instance of signals of the time-of-flight measurement) as an input value for the machine learning model. In other words, the machine learning model can be trained, on the basis of data from a time-of-flight distance measurement of the distance between the key device and the vehicle and on the basis of a signal strength of a signal transmission between the key device and the vehicle, to determine a position of the key device relative to the vehicle. In this case, the key device may be, for instance, a radio key (also key fob) or a mobile device, for instance a programmable mobile telephone (smartphone) or a so-called wearable (mobile device which can be worn on the body). The time-of-flight distance measurement and/or the received signal strength may be based on one or more signals from an ultra-wideband (UWB) signal transmission. Other high-frequency (HF, also radio frequency, RF) or low-frequency (LF) signal transmissions can nevertheless also be used to measure the time-of-flight and to measure the receive signal strength.

The time-of-flight distance measurement and optionally the receive signal strength may be used in this case as input values for the machine learning model, and an item of information relating to the corresponding position of the key device relative to the vehicle may be provided by the machine learning model as an output value. In this case, the input values are also referred to as so-called “features”. In order to now train a machine learning model (using a so-called supervised learning approach), the corresponding input data and output data are used as training input data and training output data and the machine learning model is trained to provide a transformation which generates corresponding output data for all training data sets from the training input data. Machine learning models can be trained using training input data. The examples mentioned above use a training method which is called “supervised learning”. In supervised learning, the machine learning model is trained using a plurality of training data units, wherein each data unit comprises one or more training input data items and one or more desired output values, that is to say a desired output value is assigned to the combination of the one or more training input data items. As a result of both training input data and desired output values being specified, the machine learning model “learns” which output value needs to be provided on the basis of input data which are similar to the training input data provided during training. In the presented method, the data from the time-of-flight distance measurement of the distance between the key device and the vehicle and optionally the signal strength of the signal transmission between the key device and the vehicle represent the input data, that is to say also the training input data, and the position of the key device relative to the vehicle represents the output data, that is to say also the training output data. In other words, the machine learning model is trained to output the position of the key device relative to the vehicle if data from a time-of-flight distance measurement of the distance between the key device and the vehicle and optionally the signal strength of the signal transmission are applied to the input(s) of the machine learning model. In this case, the position of the key device relative to the vehicle can be classified, for example, according to one of two or three categories, for instance “inside the vehicle interior”, “outside the vehicle” and optionally “in the trunk”. Alternatively, the position of the key device relative to the vehicle may be indicated in a sector-based system relative to the vehicle.

The machine learning model is trained on the basis of data representing at least two (or exactly two) different vehicle environments. In other words, the training data units which are used to train the machine learning model represent at least two (or exactly two) different vehicle environments. In this case, the at least two different vehicle environments may differ in relation to possible reflections at surfaces in the respective vehicle environment. For example, a first vehicle environment may be a so-called “free-field” vehicle environment, that is to say a vehicle environment in which reflections, scatterings or diffractions of the signals at objects outside the vehicle are reduced or minimized. In contrast, a second vehicle environment may be a vehicle environment in which many reflections of the respective signals may arise. For this, it is possible to select, for example, a vehicle environment in a parking garage with low ceilings and narrow side walls. In this case, the vehicle environment relates, on the one hand, to the environment of the vehicle outside the vehicle, that is to say, for instance, objects, surfaces etc. outside the vehicle. In addition, the vehicle environments may relate to objects inside the vehicle, that is to say, for instance, cargo or passengers.

In principle, there are two sources for the respective training data—on the one hand, they may be measured in “real” vehicle environments. On the other hand, they may be generated by a physical simulation. In addition, as explained yet further below, the measured or simulated data may also be supplemented with additional data units by means of so-called augmentation. For example, the data representing at least two different vehicle environments may comprise at least one first data set which was measured in a first vehicle environment. In addition, the data representing at least two different vehicle environments may comprise at least one second data set which was measured in a second vehicle environment. For this purpose, a key device in a real vehicle environment, for example, can carry out a time-of-flight measurement and optionally a receive signal strength measurement at a plurality of positions relative to the vehicle, which measurements can be used as training input data of a training data unit. The corresponding position relative to the vehicle can be used as an expected output.

Alternatively or additionally, simulated data can be used. In other words, the data representing at least two different vehicle environments may comprise at least one first data set which is based on a physical simulation of a first vehicle environment. This data set can be used together with a further simulated data set or together with a measured data set. In other words, the data representing at least two different vehicle environments may comprise at least one second data set which is based on a physical simulation of a second vehicle environment, or was measured in a second vehicle environment. For example, the physical simulation may correspond to a field simulation. For this purpose, a model of the vehicle may be created in a simulated environment. A plurality of spatial points, at which synthetic measurements are calculated on the basis of physical parameters, for instance the distance-dependent attenuation, attenuation during penetration of materials, reflections at the vehicle and in the environment, shading of the signal at parts of the vehicle and of the environment, increase in the time-of-flight and attenuation caused by non-line-of-sight transmission etc., may be defined inside and outside the vehicle. In this case, reflections outside the vehicle can be disregarded for the purpose of simulating one vehicle environment (free-field simulation). In order to simulate a further vehicle environment, a plurality of additional reflective surfaces outside and optionally inside the vehicle can be introduced into the model.

In addition to the measured or simulated data, it is possible to generate further data units representing (plausible) deviations from the measured or simulated data. In other words, the method may supplementing 110 at least one data set (of the at least two data sets) with a plurality of additional calculated data units in order to obtain the data representing the at least two different vehicle environments. In other words, the data sets which are used to train the machine learning model can be expanded with synthetically generated data units. For example, the additional data units, or at least some of the additional data units, can be calculated by adding artificial noise based on the respective data set. In other words, additional data units can be generated by adding additional stochastic or deterministic noise (that is to say pseudo-random deviations) to the data units which have been simulated or measured. Alternatively or additionally, the additional data units, or at least some of the additional data units, may be calculated by means of interpolation between the data relating to two positions on the basis of the respective data set. In other words, a third data unit can be calculated, from two data units calculated for two positions relative to the vehicle, for a position which is between the two positions, with values which are between the values of the data units.

In some exemplary embodiments, the additional data units, or at least some of the additional data units, may be calculated on the basis of a position-dependent error model based on the respective data set. This position-dependent error model is based on the fact that no signals are received at particular positions relative to the vehicle in the free field, but a signal is received in reflective environments. This property can be modeled as an error model and can be used to generate such errors produced by environmental influences. In the position-dependent error model, the areas around the vehicle can be divided into smaller zones, for example. For each zone, it is possible to determine which characteristic changes in the features occur in the different environments. A zone-specific environmental interference model can be generated therefrom, that is to say a model which specifically models the interfering influence of the different environments for each zone. Its use is an augmentation which uses the recorded training data relating to an environment in order to generate further training data which represent other environments. These further training data can then be used to train the machine learning model.

The interface 12 may correspond, for example, to one or more inputs and/or one or more outputs for receiving and/or transmitting information, for instance in digital bit values, on the basis of a code, inside a module, between modules or between modules of different entities.

In exemplary embodiments, the one or more processors 14 may correspond to any desired controller or processor or a programmable hardware component. For example, the one or more processors 14 may also be implemented as software which is programmed for a corresponding hardware component. In this respect, the one or more processors 14 may be implemented as programmable hardware with accordingly adapted software. In this case, any desired processors, such as digital signal processors (DSPs), can be used. In this case, exemplary embodiments are not restricted to a particular type of processor. Any desired processors or a plurality of processors are conceivable for implementation.

The one or more memory devices 16 may comprise, for example, at least one element of the group comprising a computer-readable storage medium, a magnetic storage medium, an optical storage medium, a hard disk, a flash memory, a floppy disk, a random access memory, a programmable read-only memory (PROM), an erasable programmable read-only memory (EPROM), an electronically erasable programmable read-only memory (EEPROM) and a network memory.

Machine learning algorithms are normally based on a machine learning model. In other words, the term “machine learning algorithm” may denote a set of instructions which can be used to create, train or use a machine learning model. The term “machine learning model” may denote a data structure and/or a set of rules representing the knowledge learnt (for example on the basis of the training carried out by means of the machine learning algorithm). In exemplary embodiments, the use of a machine learning algorithm may imply the use of an underlying machine learning model (or a plurality of underlying machine learning models). The use of a machine learning model may imply that the machine learning model and/or the data structure/the set of rules, which is/are the machine learning model, is/are trained by means of a machine learning algorithm.

For example, the machine learning model may be an artificial neural network (ANN). ANNs are systems which are inspired by biological neural networks, as can be found in a retina or a brain. ANNs comprise a plurality of interconnected nodes and a plurality of connections, so-called edges, between the nodes. There are normally three node types: input nodes which receive input values, concealed nodes which are connected (only) to other nodes, and output nodes which provide output values. Each node may represent an artificial neuron. Each edge may send information from one node to another. The output of a node may be defined as a (non-linear) function of the inputs (for example the sum of its inputs). The inputs of a node may be used in the function on the basis of a “weight” of the edge or of the node which provides the input. The weight of nodes and/or of edges can be adapted in the learning process. In other words, the training of an artificial neural network may comprise adapting the weights of the nodes and/or edges of the artificial neural network, that is to say in order to achieve a desired output for a particular input.

Alternatively, the machine learning model may be a support vector machine, a random forest model or a gradient boosting model. Support vector machines are supervised learning models with associated learning algorithms which can be used to analyze data (for example in a classification or regression analysis). Support vector machines may be trained by providing an input having a plurality of training input values which belong to one of two categories. The support vector machine may be trained to assign a new input value to one of the two categories. Alternatively, the machine learning model may be a Bayesian network which is a probabilistic directed acyclic graphical model. A Bayesian network may represent a set of random variables and their conditional dependencies using a directed acyclic graph. Alternatively, the machine learning model may be based on a genetic algorithm which is a search algorithm and heuristic technology which imitates the process of natural selection.

More details and aspects of the method and of the device are mentioned in connection with the concept or examples described above or below (for instance FIGS. 2a and 2b). The method and the device may comprise one or more additional optional features which correspond to one or more aspects of the proposed concept or of the described examples, as described above or below.

FIG. 2a shows a flowchart of an exemplary embodiment of a method, for instance a computer-implemented method, for generating data sets for training a machine learning model. The data sets each comprise a plurality of data units with a position of a key device relative to a vehicle, a time-of-flight distance measurement between the key device and the vehicle and/or a signal strength of a signal transmission between the key device and the vehicle. The method comprises generating 210 a first data set in a first vehicle environment. The method also comprises generating 220 a second data set in a second vehicle environment. The vehicle environments differ in relation to possible reflections at surfaces in the respective vehicle environment (as already explained, for instance, in connection with FIG. 1a and/or 1b).

FIG. 2b shows a block diagram of an exemplary embodiment of a corresponding computer-implemented device 20 for generating data sets for training a machine learning model. The device comprises one or more processors 24 and one or more memory devices 26. The device also optionally comprises an interface 22, for instance for receiving the training data or for providing the trained machine learning model. The one or more processors are coupled to the optional interface and to the one or more memory devices. The functionality of the device is generally provided by the one or more processors with the aid of the one or more memory devices and/or the optional interface. The device is designed to carry out the method from FIG. 2a.

The following description relates both to the method from FIG. 2a and to the corresponding device from FIG. 2b.

Some exemplary embodiments of the present disclosure relate to the generation of training data for training a machine learning model, for instance the machine learning model from FIG. 1a and/or 1b. The method is suitable for generating data sets for training the machine learning model. The data sets each comprise a plurality of data units with a position of the key device relative to the vehicle (as an expected output value), a time-of-flight distance measurement between the key device and the vehicle (as a training input data item) and/or a signal strength of a signal transmission between the key device and the vehicle (as a training input data item).

As already indicated in connection with FIG. 1a and/or 1b, the training data may fundamentally be generated using two approaches—using measurements and using physical simulations.

For example, the process of generating 210 the first data set in the first vehicle environment may comprise carrying out a plurality of measurements for determining the time-of-flight distance measurement and/or the signal strength of the signal transmission in the first vehicle environment for a plurality of positions of the key device relative to the vehicle, for instance at a plurality of predefined positions inside and outside the vehicle. Similarly, the process of generating 220 the second data set in the second vehicle environment may comprise carrying out a plurality of measurements for determining the time-of-flight distance measurement and/or the signal strength of the signal transmission in the second vehicle environment for a plurality of positions of the key device relative to the vehicle, for instance at the plurality of predefined positions inside and outside the vehicle.

Alternatively or additionally, simulated data may be used. For example, the process of generating 210 the first data set in the first vehicle environment may comprise carrying out a physical simulation for determining the time-of-flight distance measurement and/or the signal strength of the signal transmission in a model of the first vehicle environment for a plurality of positions of the key device relative to the vehicle, for instance at a plurality of predefined positions inside and outside the vehicle in the model. Similarly, the process of generating 220 the second data set in the second vehicle environment may comprise carrying out a physical simulation for determining the time-of-flight distance measurement and/or the signal strength of the signal transmission in a model of the second vehicle environment for a plurality of positions of the key device relative to the vehicle, for instance at the plurality of predefined positions inside and outside the vehicle in the model.

Details of the two approaches and of the two vehicle environments which differ in relation to possible reflections at surfaces in the respective vehicle environment have already been mentioned in connection with the description of FIGS. 1a and 1b. These are expounded further below.

In some exemplary embodiments, the method also comprises training 230 the machine learning model on the basis of the generated data sets, for instance in a similar manner to the training 120 of the machine learning model from FIG. 1a. This may comprise supplementing 110 the data sets, for example.

The interface 22 may correspond, for example, to one or more inputs and/or one or more outputs for receiving and/or transmitting information, for instance in digital bit values, on the basis of a code, inside a module, between modules or between modules of different entities.

In exemplary embodiments, the one or more processors 24 may correspond to any desired controller or processor or a programmable hardware component. For example, the one or more processors 24 may also be implemented as software which is programmed for a corresponding hardware component. In this respect, the one or more processors 24 may be implemented as programmable hardware with accordingly adapted software. In this case, any desired processors, such as digital signal processors (DSPs), can be used. In this case, exemplary embodiments are not restricted to a particular type of processor. Any desired processors or a plurality of processors are conceivable for implementation.

The one or more memory devices 26 may comprise, for example, at least one element of the group comprising a computer-readable storage medium, a magnetic storage medium, an optical storage medium, a hard disk, a flash memory, a floppy disk, a random access memory, a programmable read-only memory (PROM), an erasable programmable read-only memory (EPROM), an electronically erasable programmable read-only memory (EEPROM) and a network memory.

More details and aspects of the method and of the device are mentioned in connection with the concept or examples described above or below (for instance FIGS. 1a and 1b). The method and the device may comprise one or more additional optional features which correspond to one or more aspects of the proposed concept or of the described examples, as described above or below.

Exemplary embodiments of the present disclosure are based on the fact that two environments (for instance two vehicle environments) are taken as a basis for training the machine learning model. In some exemplary embodiments, training data are therefore recorded in precisely two environments, instead of in all possible environments. These two environments represent, in terms of their character, two extremes which can generally occur in environments. The first environment should be an environment free of any reflections. This environment is called a “free field” below. In this case, it can be ensured that there is no metal/reflective object in a radius of at least 5 m. This makes it possible to ensure that the received UWB packets could have arrived at the respective anchors solely on “line-of-sight” (LOS) paths. This in turn results in the availability of the anchors being rather low. In this context, “availability” represents the relationship between received packets and transmitted packets.

As a second environment, a very highly reflective environment is proposed, for instance an underground garage with a low ceiling height. In addition, the selected parking bay may be surrounded by two reinforced concrete walls, with the result that reflections occur both above the vehicle and beside the vehicle. In this environment, the anchor availability is considerably higher since packets can also be interchanged on “non-LOS” paths.

A large part of the complete solution space (for example supermarket parking lot or parking at the edge of the road) can be covered with the aid of the training data from these two environments.

Training in a plurality of environments can be improved by means of further approaches. In some exemplary embodiments, additional data processing algorithms and data augmentations are therefore used to train the ML model in different environments.

Some exemplary embodiments are based on synthetic generation of training data with field simulation (augmentation). In order to keep the effort involved in acquiring the training data even lower, it is possible to use synthetically generated data on the basis of physical models in the training algorithm instead of measured data. A so-called field simulation generates spatial points in the vehicle and around the vehicle. The values for the corresponding points can now be calculated on the basis of physical models. The challenge here involves modeling the vehicle and the environment. Which parts of the vehicle result in the complete shading of the signal? Which parts of the vehicle cause greater attenuation of the signal? Through which regions of the vehicle is the signal conducted with an increased ToF as a result of multiple reflections? In one exemplary implementation, the model was constructed as follows.

Spatial points outside the vehicle are generated with the aid of the following parameters:
minDistCar (indicates the minimum distance to the vehicle from which points are generated)
maxDistCar (indicates the maximum distance to the vehicle up to which points are generated)
gridDist (indicates the distance between the points)
zPoints (indicates the number of planes in the z direction in which points are generated)

In accordance with the parameters, spatial points are produced around the contour of the vehicle. In a simplified calculation, a cuboid with the maximum dimensions of the vehicle is assumed as the contour of the vehicle. For the calculation of the features, receive signal strength (RXP) and distance (range), the positions of the anchors should likewise also be known.

The vector from each anchor to each generated spatial point can be established first. The length of these vectors provides the first approximation for calculating the two features, distance and receive signal strength. The point at which these vectors leave the contour of the vehicle can then be determined and the length of the path through the vehicle can be calculated. The length of these vectors inside the vehicle contour can be taken as a basis for estimating additional attenuation.

At this point, this simulation comprises only data for free-field conditions (no reflections, only LOS connections). In order to also simulate data from other environments, the model can also be equipped with different reflective surfaces, with the result that NLOS paths (non-line-of-sight paths) are also possible. In addition, the vehicle model can also be concretized. As a result of the fact that only a limited number of connections are established and there is not an infinite number of receiving nodes, no complete simulation of all beams is required in some exemplary embodiments.

In some exemplary embodiments, synthetic generation of training data is tracked with stochastic noise (augmentation). As a second processing step, it is possible to use a process which generates additional training data by changing existing training data with an interference process. Additional data units can consequently be added to the training data. This interference process may be either stochastic or deterministic. This applied perturbation simulates, for example, interference on the path of the connection, for example through a body part or a pocket with contents. Uniformly distributed noise in the receive signal data up to a limit of 10 dB has been found to be expedient.

In some exemplary embodiments, synthetic generation of training data is tracked with an error model (augmentation). In the analysis of the data, it is shown that, in particular zones, particular anchors do not provide a signal in the free field, but a signal is received in reflective environments. This property can be modeled as an error model and can be used to generate such errors which are generated by environmental influences.

At least some exemplary embodiments therefore determine a zone-specific environmental model. For this purpose, the areas around the vehicle are divided into smaller zones, for example. For each zone, it is possible to determine which characteristic changes in the features occur in the different environments. A zone-specific environmental interference model is generated therefrom, that is to say a model which specifically models the interfering influence of the different environments for each zone. Its use is an augmentation which uses the recorded training data relating to an environment to generate further training data which represent other environments. These further training data can then be used to train the machine learning model.

Exemplary embodiments therefore provide a method which records measurement data in different environments. In this case, the training data can be recorded, for example, in two different specified environments (free field, underground garage). Exemplary embodiments also provide a method for generating additional training data (augmentation) for improving the performance of the ML model. In this case, additional training data on the basis of the measured training data may be included in the formation of the ML model. For example, already existing training data, to which a position-independent interference process has been applied, may be added as additional training data. For example, for augmentation, it is possible to add additional points to the training which spatially between two points belong to the same class. For example, already existing training data, to which a position-dependent interference process has been applied, can be added as additional training data. Alternatively or additionally, additional synthetically generated training data may be included in the formation of the ML model. In some exemplary embodiments, spatial points may be generated outside the vehicle and the feature values may be calculated on the basis of physical models.

The aspects and features which are described together with one or more of the examples and figures detailed above can also be combined with one or more of the other examples in order to replace an identical feature of the other example or to additionally introduce the feature into the other example.

Examples may also be or relate to a computer program having a program code for carrying out one or more of the above methods when the computer program is executed on a computer or processor. Steps, operations or processes of different methods described above may be carried out by means of programmed computers or processors. Examples may also cover program memory devices, for example digital data storage media, which are machine-readable, processor-readable or computer-readable and code machine-executable, processor-executable or computer-executable programs of instructions. The instructions carry out some or all of the steps of the methods described above or cause them to be carried out. The program memory devices may comprise or be, for example, digital memories, magnetic storage media, for example magnetic disks and magnetic tapes, hard disk drives or optically readable digital data storage media. Further examples may also cover computers, processors or control units which are programmed to carry out the steps of the methods described above, or (field-)programmable logic arrays ((F)PLAs) or (field-)programmable gate arrays ((F)PGAs) which are programmed to carry out the steps of the methods described above.

The description and drawings present only the principles of the disclosure. Furthermore, all examples mentioned here are intended to be used expressly only for illustrative purposes, in principle, in order to assist the reader in understanding the principles of the disclosure and the concepts contributed by the inventor(s) for further development of the art. All statements herein regarding principles, aspects and examples of the disclosure and also specific examples thereof encompass the counterparts thereof.

Functions of different elements shown in the figures including those function blocks referred to as “means”, “means for providing a signal”, “means for generating a signal”, etc. can be implemented in the form of dedicated hardware, e.g. “a signal provider”, “a signal processing unit”, “a processor”, “a controller”, etc., and as hardware capable of executing software in conjunction with associated software. When provided by a processor, the functions can be provided by a single dedicated processor, by a single jointly used processor or by a plurality of individual processors, some or all of which can be used jointly. However, the term “processor” or “controller” is far from being limited to hardware capable exclusively of executing software, but rather can encompass digital signal processor hardware (DSP hardware), a network processor, an application-specific integrated circuit (ASIC), a field-programmable logic array (FPGA), a read-only memory (ROM) for storing software, a random access memory (RAM) and a non-volatile memory device (storage). Other hardware, conventional and/or customized, can also be included.

A block diagram can illustrate for example a rough circuit diagram which implements the principles of the disclosure. In a similar manner, a flow diagram, a flowchart, a state transition diagram, a pseudo-code and the like can represent various processes, operations or steps which are represented for example substantially in a computer-readable medium and are thus performed by a computer or processor, regardless of whether such a computer or processor is explicitly shown. Methods disclosed in the description or in the patent claims can be implemented by a component having a means for performing each of the respective steps of said methods.

It goes without saying that the disclosure of a plurality of steps, processes, operations or functions disclosed in the description or the claims should not be interpreted as being in the specific order, unless this is explicitly or implicitly indicated otherwise, e.g. for technical reasons. The disclosure of a plurality of steps or functions therefore does not limit them to a specific order unless said steps or functions are not interchangeable for technical reasons. Furthermore, in some examples, an individual step, function, process or operation can include a plurality of substeps, subfunctions, subprocesses or suboperations and/or be subdivided into them. Such substeps can be included and be part of the disclosure of said individual step, provided that they are not explicitly excluded.

Furthermore, the claims that follow are hereby incorporated in the detailed description, where each claim can be representative of a separate example by itself. While each claim can be representative of a separate example by itself, it should be taken into consideration that—although a dependent claim can refer in the claims to a specific combination with one or more other claims—other examples can also encompass a combination of the dependent claim with the subject matter of any other dependent or independent claim. Such combinations are explicitly proposed here, provided that no indication is given that a specific combination is not intended. Furthermore, features of a claim are also intended to be included for any other independent claim, even if this claim is not made directly dependent on the independent claim.

1.-10. (canceled)

11. A computer-implemented method for training a machine learning model, the method comprising:
training the machine learning model on the basis of data representing at least two different vehicle environments,
wherein the machine learning model is trained, on the basis of data from a time-of-flight distance measurement of a distance between a key device and a vehicle, to determine a position of the key device relative to the vehicle.

12. The method as claimed in claim 11, wherein the at least two different vehicle environments differ in relation to possible reflections at surfaces in the two different vehicle environments.

13. The method as claimed in claim 11, wherein the data representing at least two different vehicle environments comprise at least one first data set measured in a first vehicle environment, and at least one second data set measured in a second vehicle environment.

14. The method as claimed in claim 11, wherein the data representing at least two different vehicle environments comprise at least one first data set, which is based on a physical simulation of a first vehicle environment, and at least one second data set, which is based on a physical simulation of a second vehicle environment, or was measured in a second vehicle environment.

15. The method as claimed in claim 11, comprising supplementing at least one data set with a plurality of additional calculated data units in order to obtain the data representing the at least two different vehicle environments.

16. The method as claimed in claim 15, wherein the additional data units are calculated by adding artificial noise on the basis of a respective data set,
and/or wherein the additional data units are calculated on the basis of a position-dependent error model based on the respective data set,
and/or wherein the additional data units are calculated by means of interpolation between the data relating to two positions on the basis of the respective data set.

17. The method as claimed in claim 16, wherein the time-of-flight distance measurement and/or a received signal strength is/are based on one or more signals from an ultra-wideband signal transmission,
and/or wherein the machine learning model is trained, on the basis of data from a time-of-flight distance measurement of a distance between a key device and a vehicle, and on the basis of a signal strength of a signal transmission between the key device and the vehicle, to determine the position of the key device relative to the vehicle.

18. The method as claimed in claim 16, wherein the additional data units are calculated by adding artificial noise on the basis of the respective data set.

19. The method as claimed in claim 16, wherein the additional data units are calculated on the basis of a position-dependent error model based on the respective data set.

20. The method as claimed in claim 16, wherein the additional data units are calculated by means of interpolation between the data relating to two positions on the basis of the respective data set.

21. The method as claimed in claim 11, wherein the time-of-flight distance measurement and/or a received signal strength is/are based on one or more signals from an ultra-wideband signal transmission,
and/or wherein the machine learning model is trained, on the basis of data from a time-of-flight distance measurement of a distance between a key device and a vehicle, and on the basis of a signal strength of a signal transmission between the key device and the vehicle, to determine the position of the key device relative to the vehicle.

22. A method for generating data sets for training a machine learning model, wherein the data sets each comprise a plurality of data units with a position of a key device relative to a vehicle, a time-of-flight distance measurement between the key device and the vehicle and/or a signal strength of a signal transmission between the key device and the vehicle, the method comprising:
generating a first data set in a first vehicle environment; and
generating a second data set in a second vehicle environment,
wherein the two vehicle environments differ in relation to possible reflections at surfaces in the two vehicle environments.

23. The method as claimed in claim 22, further comprising:
generating the first data set based on a physical simulation of a first vehicle environment, and
generating the second data set based on a physical simulation of a second vehicle environment, or based on measurements in a second vehicle environment.

24. The method as claimed in claim 22, comprising supplementing at least one of the first and second data sets with a plurality of additional calculated data units.

25. The method as claimed in claim 24, wherein the additional data units are calculated by adding artificial noise on the basis of a respective data set,
and/or wherein the additional data units are calculated on the basis of a position-dependent error model based on the respective data set,
and/or wherein the additional data units are calculated by means of interpolation between the data relating to two positions on the basis of the respective data set.

26. A program having a program code for carrying out at least one of the methods as claimed in claim 11 when the program code is executed on a computer, a processor, a control module or a programmable hardware component.

27. The program as claimed in claim 26, wherein the at least two different vehicle environments differ in relation to possible reflections at surfaces in the two different vehicle environments.

28. A computer-implemented device for training a machine learning model, the device comprising one or more processors and one or more memory devices, wherein the device is designed to carry out the method as claimed in claim 11.
